(19) United States
(12) Patent Application Publication
(10) Pub. No.: US 2018/0283845 A1
(43) Pub. Date: Oct. 4, 2018

(54) WAVELENGTH MODULATABLE INTERFEROMETER

(71) Applicant: Intel Corporation, Santa Clara, CA (US)

(72) Inventors: Mario Pacheco, Tempe, AZ (US); Manish Dubey, Chandler, AZ (US); Purushotham Kaushik Muthur Srinath, Chandler, AZ (US); Deepak Goyal, Phoenix, AZ (US); Liwen Jin, Chandler, AZ (US)

(21) Appl. No.: 15/476,187

(22) Filed: Mar. 31, 2017

(51) Int. Cl. G01B 9/02; G01B 11/00

(52) U.S. Cl. CPC G01B 9/02; G01B 11/00

(57) ABSTRACT

An interferometer for characterizing a sample, the interferometer including a light emitter to produce a light beam. A wavelength modulator can dither a wavelength of the light beam to produce an input beam having an oscillating wavelength. A beam splitter can be configured to divide the input beam into a reference beam and a measurement beam. The reference beam can reflect from a mirror having a fixed position and return to the beam splitter. The measurement beam can reflect from the sample and return to the beam splitter. The beam splitter can interfere the received reference beam and measurement beam to form an output beam. A detector can convert the output beam to an electrical signal. A processor can control the wavelength modulator, receive the electrical signal, and determine a distance to the sample based on the electrical signal and the oscillating wavelength of the input beam.

### TECHNICAL FIELD

This document pertains generally, but not by way of limitation, to devices and methods for metrology, such as laser interferometry.

### BACKGROUND

Existing devices for measuring small components or assemblies (such as integrated circuits) include profilometers, confocal interferometers, and destructive metrology techniques. In the semiconductor industry, integrated circuits are often screened after production to check for process abnormalities or out-of-specification parameters. For instance, measuring surface profiles of integrated circuits can provide insight into process abnormalities by detecting deviations in the surface topology and shape of the integrated circuit.

Many profilometers reflect a fixed-wavelength laser light off a sample to be measured. Profilometers can calculate a variation in height of the sample based on a phase shift between two beams split from a common source beam. For instance, a first portion of the laser beam can be reflected off the sample and another portion of the laser beam can be reflected off a mirror. The position of the mirror can be adjusted until the laser beam from the sample and the laser beam from the mirror are in phase. Accordingly, a height difference on the sample can be measured by tracking the amount of mirror movement results in synchronization of the two beams. In other words, the movement of the mirror can be calibrated to correspond to height variations of the sample. The mirror can be moved mechanically or manually depending upon the configuration. Often, calibrations are conducted regularly to minimize measurement error. There exists a need for more accurate metrology tools with faster sampling rates.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a wavelength-modulatable interferometer, according to an embodiment.

FIG. 2 is a diagram of an input beam having an oscillating wavelength, according to an embodiment.

FIG. 3 is a diagram of an electronic signal based on a light beam with an oscillating wavelength received at a detector, according to an embodiment.

FIG. 4 depicts an example of a wavelength-modulatable interferometer including a confocal mode, according to an embodiment.

FIG. 5 is block diagram of an exemplary technique for characterizing a sample, according to an embodiment.

### DETAILED DESCRIPTION

The present application relates to devices and techniques for characterizing a sample, such as measuring a sample profile using a wavelength-modulatable interferometer. The following detailed description and examples are illustrative of the subject matter disclosed herein; however, the subject matter disclosed is not limited to the following description and examples provided. Portions and features of some embodiments may be included in, or substituted for, those of other embodiments. Embodiments set forth in the claims encompass all available equivalents of those claims.

The present inventors have recognized, among other things, that a problem to be solved can include providing an optical measurement system to measure a sample in one or more dimensions in real-time with high resolution and with fewer calibrations for maintaining accuracy. Some measurement systems detect height variations along a sample by sensing characteristics of a laser beam reflected off a surface of a sample. Some measurement systems may include one or more mechanical mechanisms for focusing the laser. Other measurement systems may split the laser beam into two portions: a first portion reflected off the sample and a second portion traveling along an adjustable path length. One or more mechanical mechanisms can adjust the location of the mirror to change the path length to calculate variations in distance to the sample. Adjusting the mechanical mechanisms can, in some examples, take a minute or longer to measure a single location on the sample. The measurement location can then be moved to measure a second location on the sample. Because these measurement systems include moving parts, in certain instances the mechanical mechanisms may require calibration to maintain the accuracy of the measurements.

The present subject matter can provide a solution to this problem, such as by determining variations in distance to a sample by dithering the wavelength of a light beam with a wavelength modulator and determining a distance to the sample based on an output beam received at a detector and the oscillating wavelength of the input beam. In one example, a wavelength-modulatable interferometer for characterizing the sample can include a light emitter, the wavelength modulator, a beam splitter, a detector, and a processor. The light emitter can produce the light beam, such as a laser light beam in the near-infrared spectrum. The wavelength modulator can dither the wavelength of the light beam to produce an input beam having an oscillating wavelength. In some examples, the wavelength modulator requires little to no calibration to maintain measurement accuracy. The beam splitter can be configured to divide the input beam into a reference beam and a measurement beam. The reference beam can reflect from a mirror having a fixed position and return to the beam splitter. The measurement beam can reflect from the sample and return to the beam splitter. The beam splitter can interfere the received reference beam and measurement beam to form an output beam. Upon receiving the output beam, the detector can convert the output beam to an electrical signal.

The processor can control the wavelength modulator, receive the electrical signal, and determine a distance to the sample based at least in part on the electrical signal and the oscillating wavelength of the input beam. Accordingly, the wavelength-modulatable interferometer can measure the profile of a sample in real-time. For instance, the wavelength-modulatable interferometer can scan the sample along one or more directions using a scanning mirror to characterize the sample in real-time. In some examples, the wavelength-modulatable interferometer can be used on a production line, such as a production line for integrated circuits, to continuously screen for process abnormalities or defective parts. For instance, the wavelength-modulatable interferometer can be used for measuring a fillet angle, through-mold-interconnect profile, integrated fan out (InFO) profile. land-side or die-side capacitor profiles, die tilt, peripheral chap gap height, die to wafer bonding, substrate cavity measurements (e.g., for silicon bridge), or other applications.

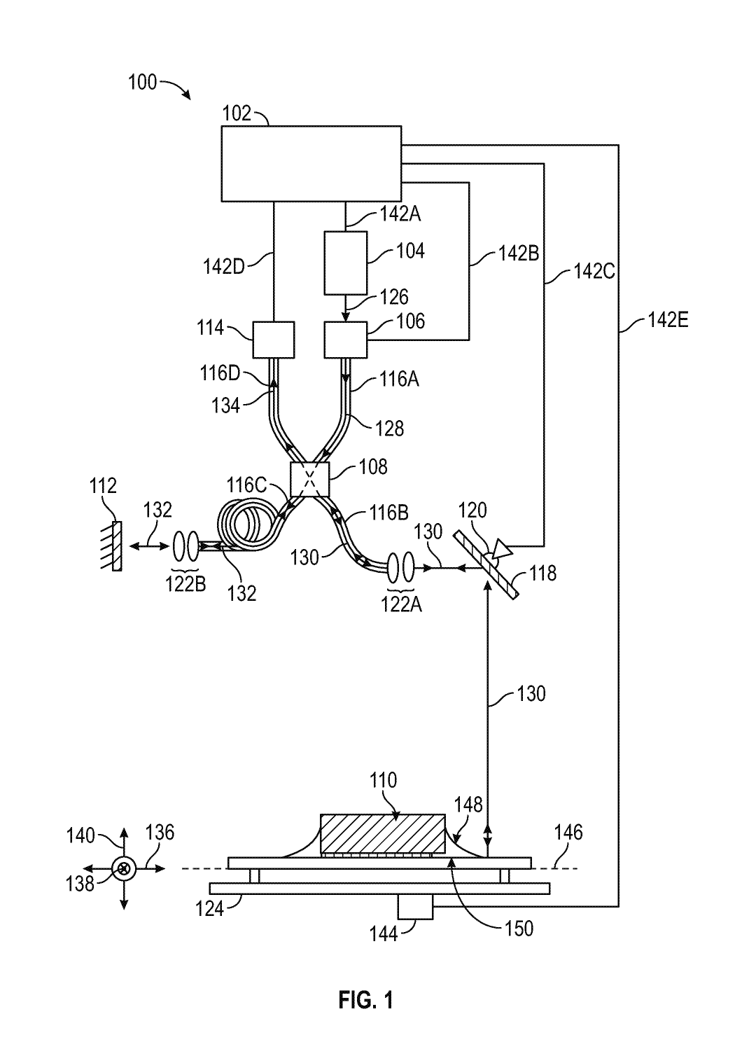

FIG. 1 illustrates an example of a wavelength-modulatable interferometer 100 configured for characterizing a sample 110, such as measuring the sample 110. The interferometer 100 can determine a distance to the sample 110 based on a wavelength oscillated light beam reflected off the sample 110. For instance, the interferometer 100 can determine an absolute distance to the sample 110. In some examples, the interferometer 100 can determine a relative distance to the sample 100, for instance, variations in distance from a reference location 146. As used herein, distance can refer to absolute distance or relative distance. In the example of FIG. 1, the interferometer 100 includes a processor 102, a light emitter 104, a wavelength modulator 106, a beam splitter 108, a reference mirror 112, and a detector 114. The light emitter 104 can be configured to produce a light beam 126. The wavelength modulator 106 can dither a wavelength of the light beam 126 to produce an input beam 128 having an oscillating wavelength. For instance, the wavelength modulator 106 can receive the light beam 126 from the light emitter 104 and generate the input beam 128 having a wavelength that changes over time (time-varying wavelength). The beam splitter 108 can divide the input beam 128 into a measurement beam 130 and a reference beam 132. In an example, the reference beam 132 can be directed toward the reference mirror 112 and reflected back to the beam splitter 108. The measurement beam 130 can be directed toward the sample 110 and be reflected back (at least in part) to the beam splitter 108. The beam splitter 108 can interfere the reference beam 132 with the measurement beam 130 to produce an output beam 134. The detector 114 can receive the output beam 134 and convert the output beam 134 into an electrical signal. The processor 102 can be communicatively coupled to the detector 114 to receive the electrical signal. In various examples, the processor 102 can control the wavelength modulator 106, receive the electrical signal, and determine the distance to the sample 110 based at least in part on the electrical signal and the oscillating wavelength of the input beam 128.

The light emitter 104 can include, but is not limited to, light emitting diode, laser (e.g., laser diode), or another light source. In the example of FIG. 1, the light emitter 104 includes a laser diode that generates a light beam in the visible, near-infrared, or infrared spectrum. For instance, the light beam 126 produced by the light emitter 104 can include a frequency between 600 and 800 nanometers or between 700 and 2,000 nanometers. In an example, the light beam 126 can be collimated.

The wavelength modulator 106 can dither the wavelength of the light beam 126 to produce the input beam 128. For instance, the wavelength modulator 106 can include a Bragg grating reflector. In an example, the wavelength modulator 106 can include a volumetric Bragg grating reflector. The Bragg grating reflector can be adjusted to dither the wavelength of the light beam 126 to produce an input beam 128 having an oscillating wavelength. As used herein, the terms oscillating, modulating, or dithering can include, but are not limited to, changes in wavelength whether continuous, intermittent, repetitive, cyclic, random, or dependent upon another input. In an example, the wavelength modulator 106 can be coupled to a microelectromechanical system (MEMS) device to generate the dithered wavelength through the wavelength modulator 106. For instance, a signal generator of the processor 102 can provide a source signal to the wavelength modulator 106. The source signal can drive the MEMS device to dither the wavelength of the light beam 126. In various examples, the wavelength of the light beam 126 can be dithered to produce an input beam 128 having an oscillation including, but not limited to, a sinusoidal, square, triangular, random, or other oscillation profile. In a further example, the wavelength of the light beam 126 can be dithered to adjust the wavelength toward a target output beam profile received at the detector 114. For instance, the wavelength can be dithered based on a feedback loop including the oscillating wavelength and the electrical signal from the detector 114.

In some examples, the interferometer 100 can optionally include a polarizer to attenuate orthogonal light waves in the input beam 128. For instance, the interferometer 100 can include an optical fiber polarizer, such as an in-line optical fiber polarizer. In an example, the polarizer can receive the input signal 128 from the wavelength modulator 106 and provide transmission of the input beam 128 though the polarizer toward the beam splitter 108.

The beam splitter 108 can divide the input beam 128 into the reference beam 132 and the measurement beam 130. In an example, the beam splitter 108 can have a fifty-fifty power splitting ratio where the input beam 128 is divided equally between the reference beam 132 and the measurement beam 130. For instance, the beam splitter 108 can include, but is not limited to, a dielectric mirror, metal coated mirror, fiber optic coupler, beam splitter cube (e.g., having two opposing triangular prisms), or the like. In the example, of FIG. 1, the beam splitter 108 is a four-port beam splitter with a fifty-fifty power splitting ratio.

The beam splitter 108 can route the reference signal to the reference mirror 112. The reference mirror 112 can be fixed in position and arranged to reflect the reference beam 132 back toward the beam splitter 108 as a reflected reference beam. The beam splitter 108 can route the measurement beam 130 toward the sample 110. The measurement beam 130 can be reflected off a surface of the sample 110 and back to the beam splitter 108 as a reflected measurement beam. In an example, a reference path length can include a distance from the beam splitter 108 to the reference mirror 112 and back to the beam splitter 108 along a path traveled by the reference beam 132. The measurement path can include a distance from the beam splitter 108 to the sample 110 and back to the beam splitter 108. In an example, the reference path length can be equal to the measurement path length at the reference location 146. For instance, the reference location 146 can be in the middle of the total measurement range of the interferometer 100. In an example, the reference location 146 can be a plane from which all measurements are based on.

The reflected reference beam 132 and measurement beam 130 can be received at the beam splitter 108 and interfered. In other words, the oscillating wave length of the reflected reference beam 132 can interfere with the oscillating wavelength of the measurement beam 130 to form the output beam 134. As referred to herein, the term interfere includes the superposition of two or more beams (e.g., the reference beam 132 and the measurement beam 130) to form a resultant wave based on the constructive and destructive interference between the beams.

In various examples, one or more of the input beam 128, the reference beam 132, the measurement beam 130, or the output beam 134 can be transmitted in free-air, though fibers (e.g., fiber-optic couplings), or via another means of transmission. In some examples, the interferometer 100 can include at least one waveguide to route the various beams (e.g., light beam 126, input beam 128, the reference beam 132, the measurement beam 130, or the output beam 134). The waveguide can include, but is not limited to, a strip, planar, rib, optical fiber, photonic-crystal fiber (PCF), or other type of waveguide. The waveguide can be solid core or hollow core and constructed of one or more materials including, glass (e.g., silica glass), polymer (e.g., Poly(methyl methacrylate)), or the like.

In the example depicted in FIG. 1, the interferometer 100 can include a network of waveguides. For instance, the interferometer 100 can include an input waveguide 116A, a measurement waveguide 116B, a reference waveguide 116C, or an output waveguide 116D. The input waveguide 116A can be coupled between the wavelength modulator 106 and the beam splitter 108 to route the input beam 128 from the wavelength modulator 106 to the beam splitter 108.

The measurement waveguide 116B can be coupled to the beam splitter 108 to route the measurement beam 130 toward the sample 110. For instance, the measurement wave guide 116B can include a first end and a second end. The first end can be coupled to the beam splitter 108 and the measurement beam 130 can be emitted from the second end toward the sample 110. In the example of FIG. 1, the interferometer 100 can include an optical collimation system 122A located at or near the second end. The optical collimation system can include at least one lens or other device to focus (collimate) the measurement beam 130 so rays of the measurement beam 130 are parallel.

The reference waveguide 116C can be coupled to the beam splitter 108 to route the reference beam 132 toward the reference mirror 112. The reference wave guide 116C can include a first end and a second end. The first end can be coupled to the beam splitter 108 and the reference beam 130 can be emitted from the second end toward the reference mirror 112. A second optical collimation system 122B can be located at or near the second end to collimate the rays of the reference beam 132 toward the reference mirror 112. As shown in the example of FIG. 1, a length of the reference waveguide 116C can be equal to the length of the measurement waveguide 116B or configured so the reference path length can be equal to the measurement path length to the reference location 146. For instance, the reference waveguide 116C can include one or more loops as depicted to extend the path length of the reference waveguide 116C.

The output waveguide 116D can be coupled between the beam splitter 108 and the detector 114 to communicate the output beam 134 from the beam splitter 108 to the detector 114. The waveguides, such as the input waveguide 116A, measurement waveguide 116B, reference waveguide 116C, or output waveguide 116D, can route one or more of the beams (input beam 128, measurement beam 130, reference beam 132, or output beam 134) along a linear or non-linear path.

Optionally, the interferometer 100 can include one or more of a scan mirror 118 or a movable sample holder 124, or both. Accordingly, the interferometer 100 can scan the sample 110 along a first direction 136 (left and right as shown in FIG. 1) or a second direction 138 (in or out of the page as shown in FIG. 1), or any combination thereof. For instance, the second direction 138 can be orthogonal to the first direction 136.

The scan mirror 118 can be rotatable about one or more axis to direct the measurement beam 130 along the surface of the sample 110. For instance, the scan mirror 118 can be coupled to an actuator 120 (e.g., galvanometer, servo, motor, or the like) controlled by the processor 102 to position (e.g., pivot) the scan mirror 118 and correspondingly direct the measurement beam 130. In one example, the processor 102 can pivot the scan mirror 118 to scan the sample 110 along the second direction 138 to generate a two-dimensional characterization of the sample 110 along the second direction 138 and a third direction 140 (vertically as shown in FIG. 1). In a further example, the scan mirror 118 can pivot about one or more axis to scan the sample along the first direction 136, the second direction 138, or both. In calculating the distance to the sample 110, the processor 102 can account for the rotation of the scan mirror 118 and calculate the distance according to the electrical signal, the oscillating wavelength of the input beam 128, and the rotation of the scan mirror 118 (e.g., number of degrees and the direction of rotation).

The sample holder 124 can translate along a first direction 136, a second direction 138, or both to scan the measurement beam 130 along the sample 110 in one or more directions. The sample holder 124 can include a platform or structure to support the sample 110 during measurement. To facilitate measurement accuracy, the sample holder 124 can include one or more pins, clamps, or fixtures having precise dimensions and alignments. In various examples, the sample holder 124 can be coupled to a actuator 144 (e.g., motor, servo, other mechanical linkage) to move the sample holder 124 along the first direction 136, second direction 138, or any combination thereof. In a further example, the sample holder 124 can be movable along the third direction 140 (vertical).

In an example, the scan mirror 118 and the sample holder 124 can be moved in conjunction to scan the sample 110 in two or more dimensions. For instance, The scan mirror 118 can be used to scan the sample 110 along the first direction 136 and the sample holder 124 can be used to scan the sample 110 along the second direction 138, or the other way around. Accordingly, the scan mirror 118 and the sample holder 124 can be used to scan the entire surface of the sample 110. Accordingly, the processor 102 can control a position of the movable sample holder 124 and determine a topology of the sample 110 based at least in part on the wavelength of the input beam 126, the position of the scan mirror 118, and the position of the movable sample holder 124.

The detector 114 can receive the output beam 134 and convert the output beam 134 to an electrical signal. In various examples, the detector 114 can include, but is not limited to, a photodiode, active-pixel sensor, charge-coupled device, HgCdTe infrared detector, reversed biased light emitting diode, photoresistor, phototransistor, or other photoelectric sensor. The detector 114 can sense light in the visible, near-infrared, or infrared spectrum. The electrical signal generated by the detector 114 can include patterns of constructive and destructive interference (e.g., an interference pattern or interference fringes) based on the output signal 134.

The processor 102 can be communicatively coupled to the detector 114, the light emitter 104, or the wavelength modulator 106, by one or more wired or wireless connections, such as wired connections 142A-E, as shown in the example of FIG. 1. In some examples, the processor 102 can include, but is not limited to, a central processing unit (CPU), graphics processing unit (GPU), microcontroller (MCU), system-on-chip (SOC), application specific integrated circuit (ASIC), field programmable gate array (FPGA), or the like.

The processor 102 can control the wavelength modulator 106, receive the electrical signal, and characterize the sample 110 based at least in part on the electrical signal and the oscillating wavelength of the input beam 128. As used herein, the term characterize can include determining one or more properties of the sample 110. For instance, the processor 102 can characterize the sample 110 by measuring a distance to the sample 110, measuring relative distances or heights of the sample 110, detecting delamination on the sample 110, measuring other dimensional properties (e.g., flatness, runout, concentricity, coplanarity, or the like). Where the processor 102 determines the distance to the sample 110, the electrical signal can correspond to a first distance where the sample 110 is in a first sample position and the electrical signal can correspond to a second distance where the sample is in a second sample position.

By controlling the wavelength of the input beam 128 using the wavelength modulator 106 and receiving characteristics of the reflected measurement beam 130 and the reflected reference beam 132 included in the electrical signal, the processor 102 can characterize the sample 110 in real-time. For instance, the processor 102 can calculate the distance to the sample 110 faster than interferometers using confocal measurement techniques or faster than a reference mirror can be adjusted mechanically for measuring the sample 110 with a Michelson interferometer. In an example, the processor 102 can determine the distance to a sample 110 in less than one-millisecond per data point. Where the processor 102 is communicatively coupled to the actuator 120 to position the scan mirror 118 or the actuator 144 to move the sample holder 124, the processor 102 can be operative to scan the sample 110 in three-dimensions (e.g., the first dimension 136, the second dimension 138, or the third dimension 140) in real-time. In one example, the processor can be operative to scan the sample 110 using one or more of the actuator 120 or the actuator 144 at a rate of 10-1000 samples (e.g., data points) per second depending on the length of measurement.

The processor 102 can control the wavelength of the input beam 128, and correspondingly, the measurement beam 130, reference beam 132, and output beam 134, using the wavelength modulator 106. For instance, the input beam 128 can include a fixed wavelength, such as a wavelength for detecting various characteristics of the sample 110. In one example, the input beam 128 can include a wavelength for detecting a surface discontinuity. For instance, where the sample 110 includes a crack (e.g., delamination between components, such as delamination between a chip and an underfill), the interferometer 100 can be operated in a discontinuity scanning mode where the wavelength of the input beam 128 can be adjusted so the surface discontinuity can be detected by the processor 102 based on the electronic signal received from the detector 114 and the wavelength of the input beam 128. For instance, in an example, the wavelength of the input beam 128 can be a fixed wavelength (such as 1300 nanometers) in the discontinuity scanning mode. In other examples, the fixed wavelength can be 600 nanometers, 1400 nanometers, or any value therebetween.

In a further example, the processor 102 compares the electrical signal with a characteristic corresponding to various distances and modulates the wavelength of the input beam 128 to synchronize the characteristic to determine the distance to the sample 110. In other words, for each measurement, the processor 102 varies the wavelength of the input beam 128 until the characteristic of the electronic signal corresponds with the distance.

Where the sample 110 includes translucent materials, the processor 102 can filter the electrical signal to determine the distance to the sample 110. For instance, translucent materials can reflect light from more than one surface of the sample 110. An air-to-surface interface 148 (upper portion of the translucent sample) may reflect a portion of the measurement beam 130 and another material interface (e.g., a lower interface 150 of the translucent material) can reflect another portion of the measurement beam 130. In some examples, the air-to-surface interface 148 can reflect a greater portion of the measurement beam 130 than other interfaces of the translucent material (e.g., the lower interface 150). In other words, stronger reflection signals can correspond to an air-to-surface interface 148 of the sample 110. Accordingly, the processor 102 can determine the distance to the sample 110 by filtering the electronic signal received from the detector 114. For instance, the processor 102 can determine the distance to the sample 110, at least in part, by filtering weaker reflection signals from stronger reflection signals.

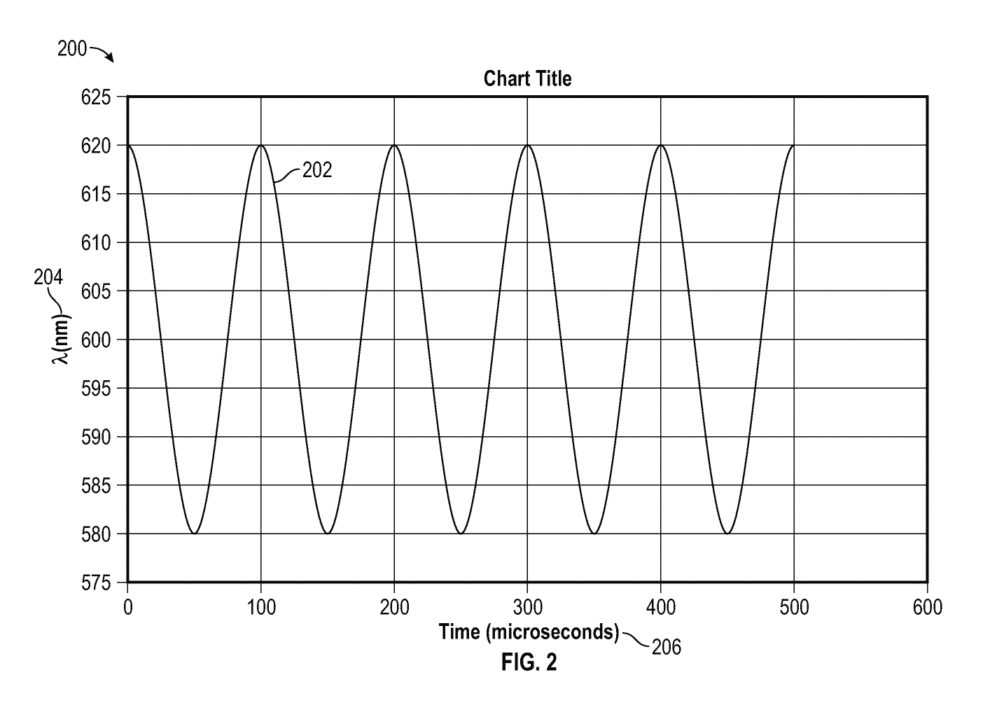

FIG. 2 is a diagram 200 of an input beam 202 having an oscillating wavelength, according to an embodiment. For instance, the input beam 202 can be an example of the input beam 128 previously described. The input beam 202 can be transmitted from the emitter 104 and modulated by the wavelength modulating device 106. In an example, the wavelength modulating device 106 can be controlled based on the source signal from the processor (e.g., signal generator of the processor 102). In the example of FIG. 2, the Y-axis represents the wavelength 204 (in nanometers) of the input beam 202 and the X-axis represents time 206 (in microseconds). As previously described, the wavelength modulator 106 (e.g., Bragg grating reflector) can be adjusted to dither the wavelength 204 of the light beam 126 to produce the input beam 202 having an oscillating wavelength. In the example of FIG. 2, the wavelength oscillates in a sinusoidal pattern; however, the present disclosure is not limited to sinusoidal profiles of oscillation. For instance, in some examples, the wavelength can be dithered to generate oscillations in a triangular, square, or other profile in a continuous, intermittent, repetitive, cyclic, random, or other oscillation profile. The range in which the wavelength 204 oscillates (e.g., 580 to 620 nm in the example of FIG. 2) can correspond to a range of distances the interferometer 100 is configured to measure (e.g., one-millimeter plus or minus from the reference location 146). In other examples, the wavelength can oscillate between 1200 and 1400 nanometers. In some examples, the wavelength can oscillate from a center frequency by 10 nanometers, 100 nanometers, or any value therebetween

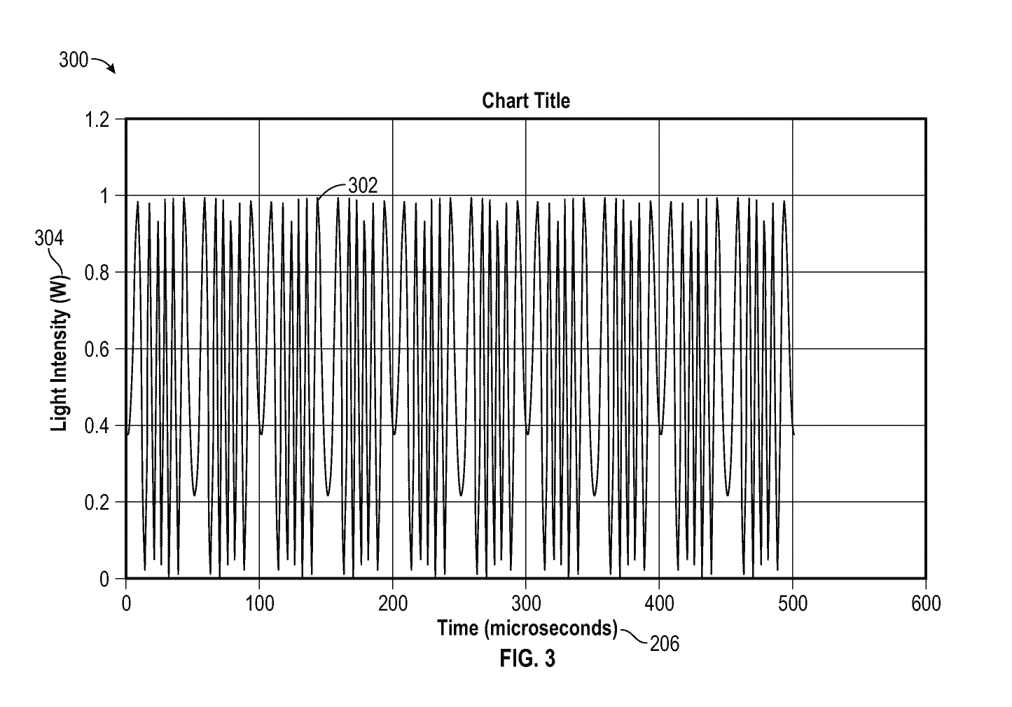

FIG. 3 is a diagram 300 of an example of an electronic signal 302 based on the light beam 202 with an oscillating wavelength received at the detector 114. The Y-axis represents the light intensity 304 (e.g., watts or watts per meter squared) of the output beam 134 and the X-axis represents time 206 (in microseconds). In one example, the time 206 can be synchronized with the clock time of the processor 102. Accordingly, the processor 102 can compare the light beam 202 with the electronic signal 302 (or the source signal) based on time 206. As shown in the example of FIG. 3, the interfered measurement beam 130 and reference beam 132 can produce an oscillating intensity 304 over time 206. In some examples, the processor 102 can determine the distance to the sample 110 based on the intensity 304, time 206, and wavelength 204 of the input beam 202 (or source signal).

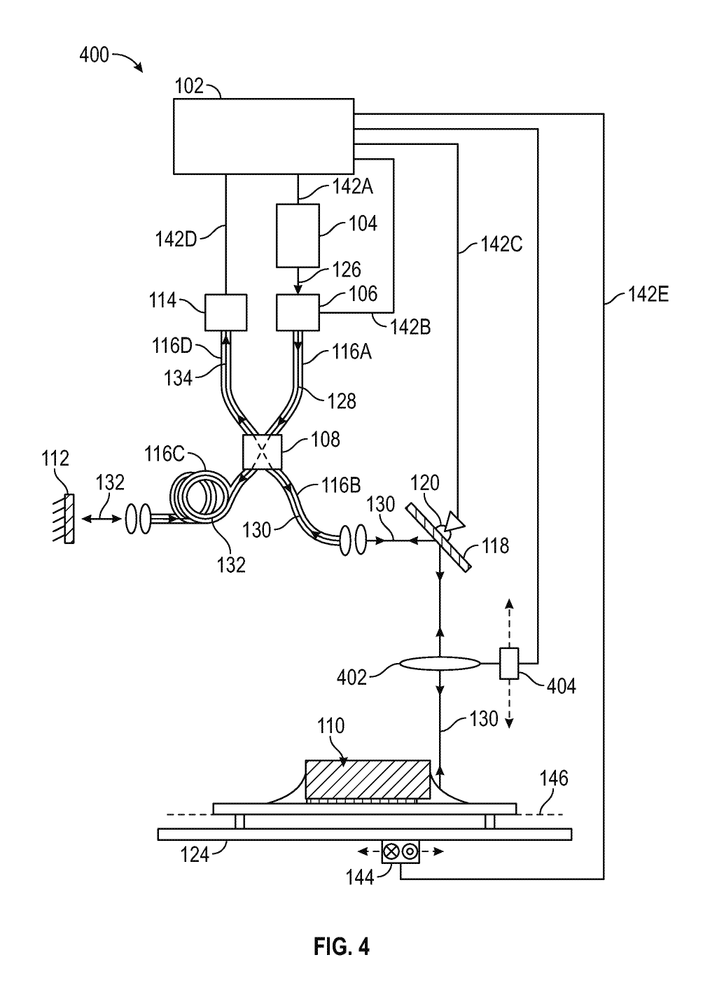

FIG. 4 depicts an example of an interferometer 400 including a confocal mode. The interferometer 400 includes the processor 102, the emitter 104, the wavelength modulator 106, the beam splitter 108, the reference mirror 112, and the detector 114 as previously described herein. In the example of FIG. 4, the interferometer 400 includes a lens 402 (e.g., a telecentric lens). The lens 402 can be adjustably positionable between an unfocused position and a focused position to focus the output beam 134 at the detector 114. For instance, the lens 402 can be coupled to an actuator 404 including, but not limited to, a motor, servo, mechanical linkage, or other actuator to move the lens 402 toward or away from the sample 110 along the measurement beam 130. In an example, the processor 102 can be communicatively coupled to the actuator 404 to control the movement of the lens 402 based on the electrical signal received from the detector 114. The processor 102 can calculate the distance to the sample 110 based on the focused position of the lens 402.

The interferometer 400 can include at least two modes: an oscillating wavelength mode, where the input beam 128 includes the oscillating wavelength and the processor 102 determines the distance to the sample 110 based at least in part on the electrical signal and the oscillating_wavelength of the input beam 128; and a confocal measurement mode, where the input beam 128 includes a fixed wavelength and the processor 102 is configured to calculate the distance to the sample based on the focused position of the lens 402. To scan and measure the sample 110 in real-time, the interferometer 400 can operate in the oscillating wavelength mode providing faster measurements along the first, second, or both directions of the sample 110. In an example, measurement accuracy in the oscillating wavelength mode can be 10 μm, 5 μm, or any resolution therebetween. Where increased measurement accuracy is desired, the interferometer 400 can operate in the confocal measurement mode. In some examples, the measurement accuracy in the confocal measurement mode can be less than 10 μm, 5 μm, or lesser resolution. Accordingly, the interferometer 400 can be used in the oscillating wavelength mode or the confocal measurement mode depending upon the application of use.

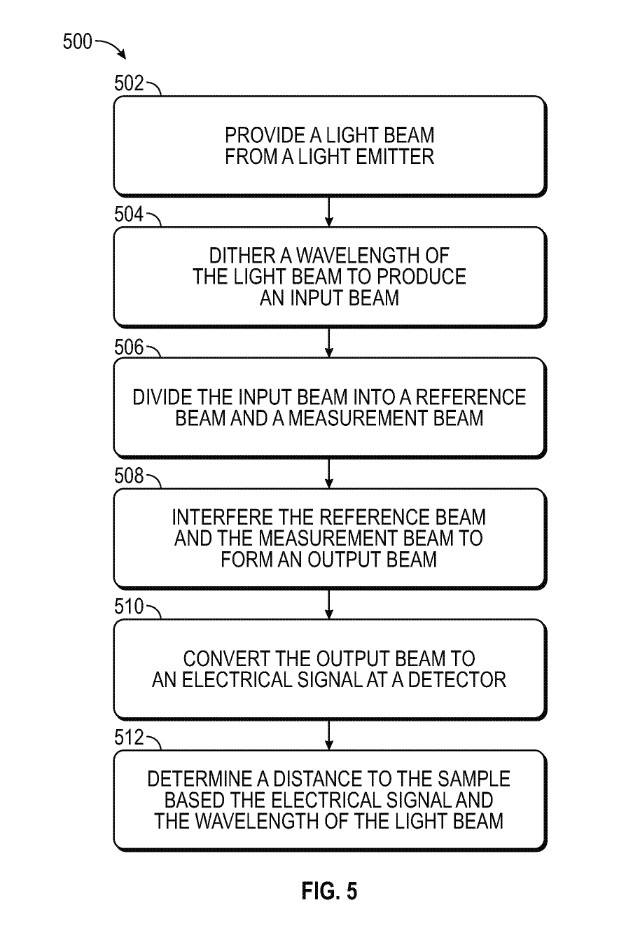

FIG. 5 is an example of a method 500 for performing an exemplary technique for measuring a sample, such as characterizing a sample using a wavelength oscillating interferometer as previously described in the examples herein and shown for instance in FIGS. 1-4. In describing the method 500, reference is made to one or more components, features, functions, and processes previously described herein. Where convenient, reference is made to the components, features, processes and the like with reference numerals. Reference numerals provided are exemplary and are nonexclusive. For instance, features, components, functions, processes, and the like described in the method 500 include, but are not limited to, the corresponding numbered elements provided herein. Other corresponding features described herein (both numbered and unnumbered) as well as their equivalents are also considered.

At 502, a light beam can be provided from a light emitter. For instance, the light beam can be provided by a light emitter, such as the light emitter 104 as previously described. In an example, the light emitter can generate the light beam in the visible, near-infrared, or infrared spectrum. For instance, the light beam produced by the light emitter can include a frequency between 600 and 800 nanometers or between 700 and 2,000 nanometers. In a further example, the light beam can be collimated and transmitted from the light emitter. In an example, the light beam can be controlled by a processor, such as the processor 102.

At 504, a wavelength of the light beam can be dithered to produce an input beam having an oscillating wavelength. In some examples, the wavelength can be dithered using a wavelength modulator, such as the wavelength modulator 106 as previously described herein. For instance, the wavelength can be dithered using a Bragg grating reflector, such as a volumetric Bragg grating reflector. The volumetric Bragg grating reflector can be movable (e.g., rotated) to modulate the wavelength of the light beam. In an example, the volumetric Bragg grating reflector can be moved with a MEMS device to produce an input beam having an oscillating wavelength.

At 506, the input beam can be divided into a reference beam and a measurement beam, such as reference beam 132 and measurement beam 130 as previously discussed. The reference beam can be reflected from a mirror (e.g., mirror 112) having a fixed position and returned to the beam splitter (e.g., beam splitter 108). The measurement beam can be reflected from the sample and returned to the beam splitter. In some examples, at least one waveguide can be configured to direct (route) the light beam, input beam, reference beam, measurement beam, output beam, or any combination thereof. For instance, a measurement beam waveguide can direct the measurement beam. A reference beam waveguide can direct the reference beam.

At 508, the beam splitter can interfere the reference beam and the measurement beam to form an output beam. In various examples, the reflected reference beam and measurement beam can be received at the beam splitter and interfered. For instance, the oscillating wave length of the reflected reference beam can interfere with the oscillating wavelength of the reflected measurement beam to form the output beam. The superposition of the reference beam and the measurement beam can form the output beam having a resultant wave based on the constructive and destructive interference between the beams.

At 510, the output beam can be converted to an electrical signal at a detector. As previously discussed, the detector, such as the detector 114, can include, but is not limited to, a photodiode, active-pixel sensor, charge-coupled device, HgCdTe infrared detector, reversed biased light emitting diode, photoresistor, phototransistor, or other photoelectric sensor. Accordingly, the detector can sense light in the visible, near-infrared, or infrared spectrum and convert the output signal into an electrical signal corresponding to the constructive and destructive interference of the output signal 134.

At 512, a distance to the sample can be determined by one or more processors based at least in part on the electrical signal and the wavelength of the input beam. For instance, the processor can compare the electrical signal to a profile of the input beam (e.g., a source signal provided to the wavelength modulator by the processor to dither the light beam). By comparing the time, wavelength, and electronic signal received by the processor, the distance to the sample (or distance from a reference location of the sample) can be determined. For instance, in a first sample position, the electrical signal corresponds to a first distance. In a second sample position, the electrical signal corresponds to a second distance.

In some examples, the processor can determine the distance to the sample in real-time as the measurement beam is scanned along the sample in one or more directions. For example, a scan mirror can be used to scan the measurement beam along the sample. The processor can control a position of the scan mirror with a galvanometer to scan linearly across the sample in a first direction, a second direction, or both. In an example, the first direction can be orthogonal to the second direction. In a further example, a sample holder can be movably arranged to scan the sample linearly, for instance, in a direction (e.g., second direction) orthogonal to the first direction, or the other way around. The position of the movable sample holder can be controlled by the processor to determine a topology of the sample based at least in part on the wavelength of the input beam, the position of the scan mirror, and the position of the movable sample holder.

In an example, the electrical signal can be filtered by the processor to determine the distance to the sample based at least in part on filtering weaker reflection signals from stronger reflection signals. When characterizing a translucent material, the measurement beam can be reflected off more than one surface of the sample. For instance, the measurement beam can be reflected off the air-to-surface interface of the sample and another surface, for example, on an opposing side of the sample. The stronger reflection signals can correspond to an air-to-surface interface of the sample. Accordingly, an air-to-surface interface of the translucent material can be measured without interference from reflected signals from another surface.

In a further example, the interferometer can be adjusted between at least two modes including, but not limited to, an oscillating wavelength mode and a confocal measurement mode. In the oscillating wavelength mode, the input beam can include an oscillating wavelength and the processor can determine the distance to the sample based at least in part on the electrical signal and the oscillating wavelength of the input beam. In the confocal measurement mode, the input beam can include a fixed wavelength, and the processor can be configured to calculate the distance to the sample based on the focused position of a lens. For instance, the lens can be adjustably positionable between an unfocused position and a focused position to focus the output beam at the detector. The processor can be configured to calculate the distance to the sample based on the focused position of the lens. Accordingly, the sample can be measured in real-time using the oscillating wavelength mode. Where measurements with a higher degree of accuracy or resolution (e.g., higher than recorded in the oscillating wavelength mode) are desired, the interferometer can be adjusted to the confocal measurement mode to detect features of the sample with a resolution or accuracy of less than 10 μm, 5 μm, or less.

### VARIOUS NOTES & EXAMPLES

Each of these non-limiting examples may stand on its own, or may be combined in various permutations or combinations with one or more of the other examples. To better illustrate the method and apparatuses disclosed herein, a non-limiting list of embodiments is provided here:

Example 1 is an interferometer for characterizing a sample, including a light emitter configured to produce a light beam; a wavelength modulator configured to dither a wavelength of the light beam to produce an input beam having an oscillating wavelength; a beam splitter configured to divide the input beam into a reference beam and a measurement beam, the reference beam directed to reflect from a reference mirror having a fixed position and return to the beam splitter, the measurement beam directed to reflect from the sample and return to the beam splitter, the beam splitter further configured to interfere the reference beam and the measurement beam to form an output beam; a detector configured to convert the output beam to an electrical signal; and a processor configured to control the wavelength modulator, receive the electrical signal, and determine a distance to the sample based at least in part on the electrical signal and the oscillating wavelength of the input beam.

In Example 2, the subject matter of Example 1 optionally includes wherein the wavelength modulator includes a volumetric Bragg grating reflector.

In Example 3, the subject matter of any one or more of Examples 1-2 optionally include a measurement beam waveguide configured to direct the measurement beam; and a reference beam waveguide configured to direct the reference beam.

In Example 4, the subject matter of any one or more of Examples 1-3 optionally include wherein the processor is configured to filter the electrical signal to determine the distance to the sample based at least in part on filtering weaker reflection signals from stronger reflection signals, wherein the stronger reflection signals correspond to an air-to-surface interface of the sample.

In Example 5, the subject matter of any one or more of Examples 1-4 optionally include wherein, in a first sample position, the electrical signal corresponds to a first distance, and in a second sample position, the electrical signal corresponds to a second distance.

In Example 6, the subject matter of any one or more of Examples 1-5 optionally include wherein the processor determines the distance to the sample in real-time as the measurement beam is scanned along the sample in one or more directions.

In Example 7, the subject matter of any one or more of Examples 1-6 optionally include a scan mirror configured to scan the measurement beam along the sample.

In Example 8, the subject matter of Example 7 optionally includes wherein the processor is further configured to control a position of the scan mirror with a galvanometer to scan linearly across the sample in a first direction.

In Example 9, the subject matter of Example 8 optionally includes a movable sample holder configured to scan the sample linearly in a second direction orthogonal to the first direction.

In Example 10, the subject matter of Example 9 optionally includes wherein the processor is further configured to control a position of the movable sample holder, and determine a topology of the sample based at least in part on the wavelength of the input beam, the position of the scan mirror, and the position of the movable sample holder.

In Example 11, the subject matter of any one or more of Examples 1-10 optionally include a lens adjustably positionable between an unfocused position and a focused position to focus the output beam at the detector, wherein the processor is configured to calculate the distance to the sample based on the focused position of the lens.

In Example 12, the subject matter of Example 11 optionally includes wherein the interferometer includes at least two modes including: an oscillating wavelength mode wherein the input beam includes the oscillating wavelength and the processor determines the distance to the sample based at least in part on the electrical signal and the oscillating wavelength of the input beam; and a confocal measurement mode wherein the input beam includes a fixed wavelength and the processor is configured to calculate the distance to the sample based on the focused position of the lens.

In Example 13, the subject matter of any one or more of Examples 1-12 optionally include a discontinuity scanning mode, wherein the input beam includes a fixed wavelength and the processor is configured to detect surface discontinuity based on the electrical signal.

Example 14 is a method of characterizing a sample, comprising: providing a light beam from a light emitter; dithering a wavelength of the light beam to produce an input beam having an oscillating wavelength; dividing the input beam into a reference beam and a measurement beam; directing the reference beam to reflect from a reference mirror having a fixed position and return to the beam splitter; directing the measurement beam to reflect from the sample and return to the beam splitter; interfering the reference beam and the measurement beam at the beam splitter to form an output beam; converting the output beam to an electrical signal at a detector; and determining a distance to the sample, by one or more processors, based at least in part on the electrical signal and the wavelength of the light beam.

In Example 15, the subject matter of Example 14 optionally includes wherein directing the reference beam and directing the measurement beam includes: directing the measurement beam through a measurement beam waveguide configured to direct the measurement beam toward the sample; and directing the reference beam through a reference beam waveguide configured to direct the reference beam toward the reference mirror.

In Example 16, the subject matter of any one or more of Examples 14-15 optionally include wherein determining a distance to the sample includes configuring the processor to filter the electrical signal to determine the distance to the sample based at least in part on filtering weaker reflection signals from stronger reflection signals, wherein the stronger reflection signals correspond to an air-to-surface interface of the sample.

In Example 17, the subject matter of any one or more of Examples 14-16 optionally include wherein determining a distance to the sample includes determining the distance to the sample in real-time as the measurement beam is scanned along the sample in one or more directions.

In Example 18, the subject matter of any one or more of Examples 14-17 optionally include scanning measurement beam along the sample with a scan mirror, wherein the processor is further configured to control a position of the scan mirror with a galvanometer to scan linearly across the sample in a first direction.

In Example 19, the subject matter of Example 18 optionally includes scanning the sample linearly in a second direction orthogonal to the first direction by controlling a position of a movable sample holder to determine a topology of the sample based at least in part on the wavelength of the input beam, the position of the scan mirror, and the position of the movable sample holder.

In Example 20, the subject matter of any one or more of Examples 14-19 optionally include adjusting the interferometer between at least two modes including: an oscillating wavelength mode wherein the input beam includes the oscillating wavelength and the processor determines the distance to the sample based at least in part on the electrical signal and the oscillating wavelength of the input beam; and a confocal measurement mode wherein the input beam includes a fixed wavelength and the processor is configured to calculate the distance to the sample based on a focused position of a lens, the lens adjustable between an unfocused position and a focused position to focus the output beam at the detector.

In Example 21, the subject matter of any one or more of Examples 14-20 optionally include a discontinuity scanning mode including detecting a surface discontinuity based on the electrical signal with a fixed wavelength from the input beam.

Example 22 is an interferometer for characterizing a sample, the interferometer comprising: a light emitter configured to produce a light beam; a Bragg grating reflector configured to dither a wavelength of the light beam to produce an input beam having an oscillating wavelength; a beam splitter configured to divide the input beam into a reference beam and a measurement beam, a reference beam waveguide configured to direct the reference beam to reflect from a reference mirror having a fixed position and return to the beam splitter, a measurement beam waveguide configured to direct the measurement beam to a scan mirror configured to scan the measurement beam along the sample along at least one direction and reflect the measurement beam from the sample and return to the beam splitter, the beam splitter further configured to interfere the reference beam and the measurement beam to form an output beam; a detector configured to convert the output beam to an electrical signal; and a processor configured to control the wavelength modulator, receive the electrical signal, and determine a distance to the sample based at least in part on the electrical signal and the oscillating wavelength of the input beam wherein the processor determines the distance to the sample in real-time as the measurement beam is scanned along the sample in one or more directions.

In Example 23, the subject matter of Example 22 optionally includes wherein the processor is configured to filter the electrical signal to determine the distance to the sample based at least in part on filtering weaker reflection signals from stronger reflection signals, wherein the stronger reflection signals correspond to an air-to-surface interface of the sample.

In Example 24, the subject matter of any one or more of Examples 22-23 optionally include wherein the processor is further configured to control a position of the scan mirror with a galvanometer to scan linearly across the sample.

In Example 25, the subject matter of any one or more of Examples 22-24 optionally include wherein the interferometer includes at least two modes including: an oscillating wavelength mode wherein the input beam includes the oscillating wavelength and the processor determines the distance to the sample based at least in part on the electrical signal and the oscillating wavelength of the input beam; and a confocal measurement mode wherein the input beam includes a fixed wavelength and the processor is configured to calculate the distance to the sample based on a focused position of a lens, the lens adjustable between an unfocused position and a focused position to focus the output beam at the detector.

In Example 26, the subject matter of any one or more of Examples 22-25 optionally include wherein, in a first sample position, the electrical signal corresponds to a first distance, and in a second sample position, the electrical signal corresponds to a second distance.

In Example 27, the subject matter of any one or more of Examples 22-26 optionally include wherein the processor determines the distance to the sample in real-time as the measurement beam is scanned along the sample in one or more directions.

In Example 28, the subject matter of any one or more of Examples 22-27 optionally include a movable sample holder configured to scan the sample linearly in a second direction.

In Example 29, the subject matter of Example 28 optionally includes wherein the processor is further configured to control a position of the movable sample holder, and determine a topology of the sample based at least in part on the wavelength of the input beam, the position of the scan mirror, and the position of the movable sample holder.

In Example 30, the subject matter of any one or more of Examples 22-29 optionally include a discontinuity scanning mode, wherein the input beam includes a fixed wavelength and the processor is configured to detect surface discontinuity based on the electrical signal.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An interferometer for characterizing a sample, comprising:
a light emitter configured to produce a light beam;
a wavelength modulator configured to dither a wavelength of the light beam to produce an input beam having an oscillating wavelength;
a beam splitter configured to divide the input beam into a reference beam and a measurement beam, the reference beam directed to reflect from a reference mirror having a fixed position and return to the beam splitter, the measurement beam directed to reflect from the sample and return to the beam splitter, the beam splitter further configured to interfere the reference beam and the measurement beam to form an output beam;
a detector configured to convert the output beam to an electrical signal; and
a processor configured to control the wavelength modulator, receive the electrical signal, and determine a distance to the sample based at least in part on the electrical signal and the oscillating wavelength of the input beam.

2. The interferometer of claim 1, wherein the wavelength modulator includes a volumetric Bragg grating reflector.

3. The interferometer of claim 1, further comprising:
a measurement beam waveguide configured to direct the measurement beam; and
a reference beam waveguide configured to direct the reference beam.

4. The interferometer of claim 1, wherein the processor is configured to filter the electrical signal to determine the distance to the sample based at least in part on filtering weaker reflection signals from stronger reflection signals, wherein the stronger reflection signals correspond to an air-to-surface interface of the sample.

5. The interferometer of claim 1, wherein; in a first sample position, the electrical signal corresponds to a first distance, and in a second sample position, the electrical signal corresponds to a second distance.

6. The interferometer of claim 1, wherein the processor determines the distance to the sample in real-time as the measurement beam is scanned along the sample in one or more directions.

7. The interferometer of claim 4, further comprising a scan mirror configured to scan the measurement beam along the sample.

8. The interferometer of claim 7, wherein the processor is further configured to control a position of the scan mirror with a galvanometer to scan linearly across the sample in a first direction.

9. The interferometer of claim 8, further comprising a movable sample holder configured to scan the sample linearly in a second direction orthogonal to the first direction.

10. The interferometer of claim 9, wherein the processor is further configured to control a position of the movable sample holder, and determine a topology of the sample based at least in part on the wavelength of the input beam, the position of the scan mirror, and the position of the movable sample holder.

11. The interferometer of claim 10, further comprising a lens adjustably positionable between an unfocused position and a focused position to focus the output beam at the detector, wherein the processor is configured to calculate the distance to the sample based on the focused position of the lens.

12. The interferometer of claim 11, wherein the interferometer includes at least two modes including:
an oscillating wavelength mode wherein the input beam includes the oscillating wavelength and the processor determines the distance to the sample based at least in part on the electrical signal and the oscillating wavelength of the input beam; and
a confocal measurement mode wherein the input beam includes a fixed wavelength and the processor is configured to calculate the distance to the sample based on the focused position of the lens.

13. The interferometer of claim 12, further comprising a discontinuity scanning mode, wherein the input beam includes a fixed wavelength and the processor is configured to detect surface discontinuity based on the electrical signal.

14. A method of characterizing a sample, comprising:
providing a light beam from a light emitter;
dithering a wavelength of the light beam to produce an input beam having an oscillating wavelength;
dividing the input beam into a reference beam and a measurement beam;
directing the reference beam to reflect from a reference mirror having a fixed position and return to the beam splitter;
directing the measurement beam to reflect from the sample and return to the beam splitter;
interfering the reference beam and the measurement beam at the beam splitter to form an output beam;
converting the output beam to an electrical signal at a detector; and
determining a distance to the sample, by one or more processors, based at least in part on the electrical signal and the wavelength of the light beam.

15. The method of claim 14, wherein directing the reference beam and directing the measurement beam includes:
directing the measurement beam through a measurement beam waveguide configured to direct the measurement beam toward the sample; and
directing the reference beam through a reference beam waveguide configured to direct the reference beam toward the reference mirror.

16. The method of claim 14, wherein determining a distance to the sample includes configuring the processor to filter the electrical signal to determine the distance to the sample based at least in part on filtering weaker reflection signals from stronger reflection signals, wherein the stronger reflection signals correspond to an air-to-surface interface of the sample.

17. The method of claim 14, wherein determining a distance to the sample includes determining the distance to the sample in real-time as the measurement beam is scanned along the sample in one or more directions.

18. The method of claim 16, further comprising scanning measurement beam along the sample with a scan mirror, wherein the processor is further configured to control a position of the scan mirror with a galvanometer to scan linearly across the sample in a first direction.

19. The method of claim 18, further comprising scanning the sample linearly in a second direction orthogonal to the first direction by controlling a position of a movable sample holder to determine a topology of the sample based at least in part on the wavelength of the input beam, the position of the scan mirror, and the position of the movable sample holder.

20. The method of claim 19, further comprising adjusting the interferometer between at least two modes including:
an oscillating wavelength mode wherein the input beam includes the oscillating wavelength and the processor determines the distance to the sample based at least in part on the electrical signal and the oscillating wavelength of the input beam; and
a confocal measurement mode wherein the input beam includes a fixed wavelength and the processor is configured to calculate the distance to the sample based on a focused position of a lens, the lens adjustable between an unfocused position and a focused position to focus the output beam at the detector.

21. The method of claim 20, further comprising a discontinuity scanning mode including detecting a surface discontinuity based on the electrical signal with a fixed wavelength from the input beam.

22. An interferometer for characterizing a sample, the interferometer comprising:
a light emitter configured to produce a light beam;
a Bragg grating reflector configured to dither a wavelength of the light beam to produce an input beam having an oscillating wavelength;
a beam splitter configured to divide the input beam into a reference beam and a measurement beam, a reference beam waveguide configured to direct the reference beam to reflect from a reference mirror having a fixed position and return to the beam splitter, a measurement beam waveguide configured to direct the measurement beam to a scan mirror configured to scan the measurement beam along the sample along at least one direction and reflect the measurement beam from the sample and return to the beam splitter, the beam splitter further configured to interfere the reference beam and the measurement beam to form an output beam;
a detector configured to convert the output beam to an electrical signal; and
a processor configured to control the wavelength modulator, receive the electrical signal, and determine a distance to the sample based at least in part on the electrical signal and the oscillating wavelength of the input beam wherein the processor determines the distance to the sample in real-time as the measurement beam is scanned along the sample in one or more directions.

23. The interferometer of claim 22, wherein the processor is configured to filter the electrical signal to determine the distance to the sample based at least in part on filtering weaker reflection signals from stronger reflection signals, wherein the stronger reflection signals correspond to an air-to-surface interface of the sample.

24. The interferometer of claim 23, wherein the processor is further configured to control a position of the scan mirror with a galvanometer to scan linearly across the sample.

25. The interferometer of claim 24, wherein the interferometer includes at least two modes including:
an oscillating wavelength mode wherein the input beam includes the oscillating wavelength and the processor determines the distance to the sample based at least in part on the electrical signal and the oscillating wavelength of the input beam; and
a confocal measurement mode wherein the input beam includes a fixed wavelength and the processor is configured to calculate the distance to the sample based on a focused position of a lens, the lens adjustable between an unfocused position and a focused position to focus the output beam at the detector.
